(19) United States
(12) Patent Application Publication
(10) Pub. No.: US 2024/0066873 A1
(43) Pub. Date: Feb. 29, 2024

(54) METHOD AND APPARATUS FOR CLEANING PRINTHEAD

(71) Applicant: HEWLETT-PACKARD DEVELOPMENT COMPANY, L.P., Spring, TX (US)

(72) Inventors: Maurizio Bordone, Sant Cugat del Valles (ES); Marian Dinares Argemi, Sant Cugat del Valles (ES); Chandrasekhar Venkata Nadimpalli, Sant Cugat del Valles (ES)

(73) Assignee: HEWLETT-PACKARD DEVELOPMENT COMPANY, L.P., Spring, TX (US)

(21) Appl. No.: 17/766,799

(22) PCT Filed: Dec. 20, 2019
(86) PCT No.: PCT/US2019/067926

§ 371 Date: Apr. 6, 2022

(51) Int. Cl. B41J 2/165; B41J 29/17

(52) U.S. Cl. CPC B41J 2/16552; B41J 29/17; B41J 2002/16558; B41J 2002/16573; B41P 2235/20

(57) ABSTRACT

A method is described in which wiping of a printhead of a printer is caused in accordance with a first wiping routine, the first wiping routine comprising periodic wiping events performed on the printhead; at least one printing parameter of a rate of an aggregation of printing liquid deposits is obtained; a second wiping routine is determined, the second wiping routine comprising periodic wiping events performed on the printhead, the wiping period of the second wiping routine being determined depending on the at least one printing parameter; and wiping of the printhead in accordance with the first and second wiping routines is caused.

### BACKGROUND

Inkjet printing mechanisms fire drops of printing liquid onto a printing medium to generate an image. Such mechanisms may be used in a wide variety of applications, including computer printers, plotters, copiers, and facsimile machines. An inkjet printing apparatus may include a printhead having a plurality of independently addressable firing units or liquid ejection devices. Each firing unit may include a liquid chamber connected to a printing liquid source and to a printing liquid outlet nozzle. A transducer within the liquid chamber provides the energy for firing drops of printing liquid from the nozzles. During printing, printing liquid may accrue on the printhead which may result in the presence of defects in a printed image.

### BRIEF INTRODUCTION OF THE DRAWINGS

Example implementations are described below with reference to the accompanying drawings, in which:

FIG. 1 is a schematic plan view of a printer;

FIG. 2 is a schematic side view of the printer along line A-A′ as indicated in FIG. 1;

FIG. 3 is an example flowchart for cleaning a printhead of a printer;

FIGS. 4a-e illustrate an example of a first wiping routine for cleaning a printhead of a printer;

FIGS. 5a-e illustrate a further example of a first wiping routine for cleaning a printhead of a printer, different to the example shown in FIGS. 4a-e;

FIGS. 6a-c illustrate an example of a second wiping routine for cleaning a printhead of a printer;

FIGS. 7a-c show example correlation tables for use in cleaning a printhead of a printer;

FIG. 8 is a schematic diagram of an example printhead of a printer; and

FIG. 9 is an example flowchart for determining a printhead temperature.

### DETAILED DESCRIPTION

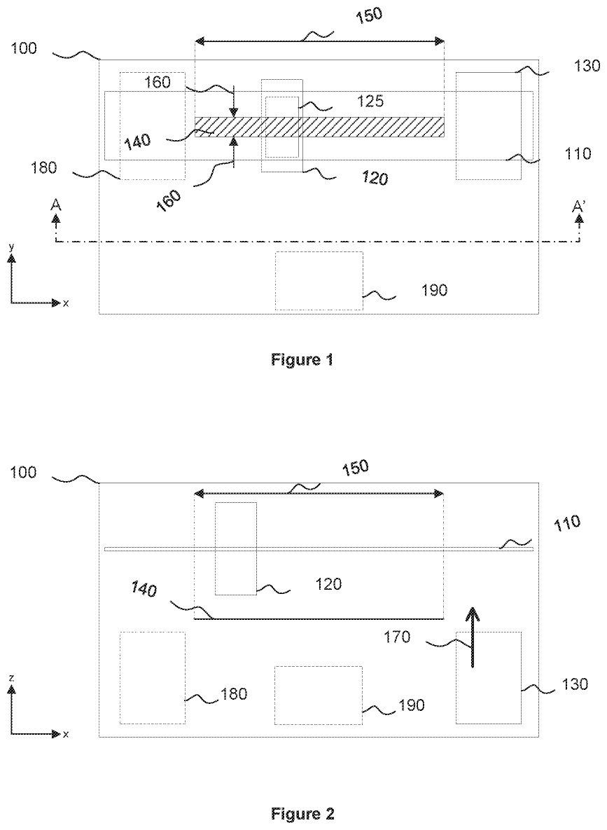

FIG. 1 is a schematic plan view of a printer 100. FIG. 2 is a schematic side view of the printer 100 along line A-A′ as indicated in FIG. 1. The printer 100 may be an inkjet printer. The printer 100 may be an industrial printer ora domestic printer. The printer 100 comprises: a beam, known as a scan beam 110, which supports a printer carriage 120; a wiping station 130; and a controller 190. While, for simplicity, the printer 100 is shown to comprise one printer carriage, the printer carriage 120, the printer 100 is not so limited and may comprise any number of printer carriages. Any further carriages may have any of the features of, and may operate similarly to, the printer carriage 120. The printer carriage 120 may comprise at least one printhead 125 which in turn may comprise a plurality of nozzles through which one or more than one printing liquids may be ejected. In some examples, the printhead 125 may also comprise one or more than one nozzle through which one or more than one liquid other than printing liquid, such as optimizer liquid, for example, may be ejected. The one or more than one printing liquids may ejected from the plurality of nozzles using any suitable inkjet printing means. In some examples, the printer 100 may be a thermal inkjet printer and may use a thermal inkjet printing process. For example, a transducer, such as a heating element, for example, may be arranged to heat the one or more than one printing liquids rapidly, thereby causing the one or more than one printing liquids to be ejected from the plurality of nozzles. In other examples, the printer 100 may be a piezoelectric inkjet printer and may use a piezoelectric inkjet printing process. For example, a piezoelectric transducer may be arranged to pressurize the one or more than one printing liquids, thereby causing the one or more than one printing liquids to be ejected from the plurality of nozzles. In other examples, the one or more than one printing liquids may be ejected from the plurality of nozzles using any other inkjet printing process or technology.

The one or more than one printing liquids may comprise one or more printing liquids associated with respective colors. For example, the one or more than one printing liquids may comprise one or more than one printing liquids associated with one of, or more than one of the following colors: cyan, magenta, yellow, black, or white. In other examples, the one or more than one printing liquids may comprise one or more than one printing liquids associated with any other color. The one or more than one printing liquids may comprise one or more than one ink suitable for use in inkjet printing. For example, the one or more than one printing liquids may comprise one or more than one of the following: dye based ink; pigment based ink; latex based ink.

In the example shown in FIGS. 1 and 2, the printer carriage 120 is arranged to traverse the scan beam 110, in a reciprocating manner, across a width of a printing zone 140. The printer carriage 120 may traverse the scan beam 110 along the x direction of FIGS. 1 and 2. The printing zone 140 may correspond to a region within which the printhead may eject ink while traversing the scan beam 110. The width of the printing zone 140 (e.g., the size of the printing zone 140 in the x direction of FIGS. 1 and 2) may be denoted a “printing zone width”. This width is shown by the arrow 150.

The printer 100 may print printing content, such as an image, or text, for example, onto a printing medium (not shown) by selectively ejecting drops of the one or more than printing liquids while the printer carriage 120 traverses the scan beam 110 across the printing zone width 150. The selectively ejected drops may form corresponding dots on the printing medium. The printed printing content on the printing medium may comprise a collection of dots at a given spatial density.

Traversing the scan beam 110, unidirectionally, from one side of the printing zone 140 to the other may be referred to as a “pass”. The direction of a pass (e.g., from left to right or right left in the example shown in FIG. 1) may be defined using the terms “forward” and “reverse”. For example, with reference to FIG. 1, traversing the scan beam 110 across the printing zone width 150 from left to right may be denoted a “forward pass” while traversing the scan beam 110 across the printing zone width 150 from right to left may be denoted a “reverse pass”. These terms are used in this manner hereinafter. This definition is arbitrary, however, and the use of “forward” and “reverse” could alternatively be used to define the opposite direction to that defined above.

A printing plane may be defined as a plane in which a printing surface of a printing medium receives printing liquid from the printhead 125. The length of the printing zone 140 in the printing plane orthogonal to the forward and reverse pass direction (e.g., the length of the printing zone 140 in they direction of FIG. 1) may be known as a “printing swath”. The printing swath is shown by the arrows 160 in FIG. 1.

The printer 100 may move the printing medium between passes in order to print the printing content onto the printing medium. In some examples, the printer 100 may move the printing medium, between passes, in a direction parallel to the printing plane and orthogonal to the direction along which the printer carriage 120 traverses the scan beam 110 (e.g., along the y axis of FIG. 1). In some examples, the printing medium may be moved, between passes, by an amount corresponding to the printing swath. In other examples, the printing medium may be moved, between passes, by any other amount.

Printing content may be printed onto the printing medium according to different printing modes. For example, a printing mode may comprise a high resolution printing mode wherein printing content is printed onto the printing medium at a high resolution (e.g., a high spatial density of dots, as quantified by dots per inch (DPI) or any other suitable metric, for example). In other examples, a printing mode may comprise a low resolution printing mode wherein printing content is printed onto the printing medium at a low resolution (e.g., a low spatial density of dots). In other examples, other printing modes may correspond to any printing resolution between the low and high resolution printing modes.

A printing job may correspond to a file or a set of files comprising information correspond to specific printing content to be printed by the printer 100 onto a printing medium. The printing job may specify, for example, the spatial location of dots to be printed and their corresponding color or tone. The printing job may also specify the printing mode to be used when printing the printing content by the printer 100.

A printing job length may correspond to a length associated with printing the corresponding printing content of the printing job. For example, the printing job length may correspond to any of the following: a time to print the printing content of the printing job; a number of passes (wherein the term “passes” is defined hereinbelow) to print the printing content of the printing job; a number of drops of the one or more than one printing liquid to print the printing job; a number of copies of printing content to be printed.

When the printer 100 prints printing content, printing liquid may aggregate on the printhead 125 of the print carriage 120. Such aggregation may result in defects in the printed printing content on the printing medium. Such defects may include, for example, micro-banding, white lines, and spray. In order to limit the aggregation of printing liquid on the printhead 125, the printhead 125 may be wiped at a wiping station 130. The wiping station 130 may be located, for example, outside of the printing zone 140 (at least during printing) and the printer carriage 120 may be selectively provided to the wiping station 130 to cause wiping of the printhead. The printer carriage 120 may be provided to the wiping station 130 by moving one of, or both the printer carriage 120 and the wiping station 130 in relation to each other.

In some examples, the printer 100 may comprise one or more than one printheads 125. It may be that each of a plurality of the said printheads is associated with a different colored printing liquid. For example, the printer 100 may comprise one printhead 125 associated with a black colored printing liquid, and one printhead 125 associated with cyan, magenta, and yellow colored printing liquids. In other examples, the printer 100 may comprise five printheads. For example, the printer 100 may comprise one printhead 125 associated a cyan colored printing liquid, one printhead 125 associated with magenta 125 colored printing liquid, one printhead 125 associated a yellow colored printing liquid, one printhead 125 associated with a black colored printing liquid, and one printhead 125 associated with a white colored printing liquid. In other examples, the printer 100 may comprise any number of printheads 125, each associated with one or more than one printing liquid.

In the example shown in FIGS. 1 and 2, the wiping station 130 is located beyond the right hand edge of the printing zone 140 in the forward pass direction. In other examples, however, the wiping station 130 may be located in any other suitable location. For example, the wiping station 130 may be located beyond the left hand edge of the printing zone 140 in the reverse pass direction, or in any other position outside of the printing zone 140.

The wiping station 130 may comprise one or more than one wiper, such as a wiping blade 170 (represented in FIG. 2 by arrow 170). In the following description it will assumed that the one or more than one wiper is one or more than one wiping blade 170, however, the one or more than one wiper may be any suitable wiper. The one or more than one wiping blade 170 may be resilient; for example the one or more than one wiping blade may be made from a resilient material. In some examples, the one or more than one wiping blade 170 may be made of rubber or silicone, for example. In other examples, the one or more than one wiping blade 170 may be made of any other suitable resilient material. In some examples, wherein there are more than one wiping blades 170, the more than one wiping blades 170 may be made of different resilient materials. In some examples, the more than one wiping blades 170 may comprise a material or materials of differing levels of hardness. In one example, the wiping station may comprise two wiping blades 170 wherein one wiping blade 170 is a “hard” wiping blade and the other wiping blade 170 is a “soft” wiping blade. For example, the hard wiping blade 170 may be harder than the soft wiping blade 170. In other examples, the wiping station 130 may comprise any number of wiping blades 170 wherein the hardness of each constituent wiping blade 170 may be either: the same as each other constituent wiping blade 170; or different from at least one or each other constituent wiping blade 170. Alternatively, one or more than one of the constituent wiping blades 170 may have the same level of hardness while one or more than one of the constituent wiping blades 170 may have a level of hardness different from one or more than one other constituent wiping blades 170.

In some examples, an absorbent material (not shown), subsequently referred to as a “cleaning cloth”, may reside on the wiping surface of the one or more than one wiping blade 170 of the wiping station 130 such that the cleaning cloth may contact the printhead 125 during wiping. The cleaning cloth may absorb residual printing liquid present on the printhead 125 during wiping. The cleaning cloth may be wet with a liquid solvent. In such examples, wiping performed by a wiping blade 170 covered by a cleaning cloth wet with a liquid solvent may be referred to as a “wet wipe”. The wiping blade 170 covered by a cleaning cloth wet with a liquid solvent may be referred to as a “wet wipe”. The solvent of the wet wipe may help to remove encrusted or polymerised ink from the printhead 125. The wiping station 130 may further comprise a liquid solvent dispenser (not shown) arranged to (e.g. automatically, e.g. periodically) dispense liquid solvent onto the cleaning cloth. It may be that the controller 190 is to communicatively coupled to the liquid solvent dispenser so as to (e.g. periodically) cause the liquid solvent dispenser to dispense liquid solvent onto the cleaning cloth. The chemical composition of the liquid solvent may be specific to the particular printing liquid to be wiped. For example, when the printing liquid comprises one of a dye-based ink, a pigment based ink, or a latex based ink, the liquid solvent may comprise: water, polyethelene glycole (PEG); any combination of water and PEG; or any other suitable solvent. Alternatively, the cleaning cloth may be coated with any other type of solvent, e.g., a solid solvent. In examples wherein the wiping station 130 comprises more than one wiping blade 170, each constituent wiping blade 170 may be a wet wipe. Alternatively, it may be that none of the constituent wiping blades 170 are wet wipes. In other examples, one or more than one of the constituent wiping blades 170 may be wet wipes while it may be that one or more than one of the constituent wiping blades are not wet wipes.

A wiping blade 170 not covered by a cleaning cloth wet with a liquid solvent may be referred to as a “dry wipe”. A “dry wipe” may be covered by a dry cleaning cloth, or it may be that a “dry wipe” is not covered by a cleaning cloth.

It may be that the one or more than one wiping blades of the wiping station 130 comprise at least one wet wipe, at least one dry wipe or at least one wet wipe and at least one dry wipe.

The wiping station 130 may be arranged to wipe a face, or at least part of a face, of the printhead 125 from which the one or more than one printing liquid is ejected. This face may be referred to as the “nozzle plate”. The wiping station 130 may be arranged to wipe all nozzles, or substantially all nozzles of the printhead 125. Alternatively, the wiping station 130 may be arranged to selectively wipe specific regions of the printhead 125. For example, the wiping station 130 may be arranged to selectively wipe a particular set or sets of nozzles of the printhead 125. Selectively wiping specific regions of the printhead 125 may inhibit cross contamination between different liquids ejected therefrom, such as cross contamination between different printing liquids or cross contamination between one or more than one printing liquid and one or more than one non-printing liquid, for example. In examples wherein there are more than one printhead 125, the wiping station may be arranged to selectively wipe one or more than one of the printheads 125, for example depending on the liquids to be ejected by the printheads 125, such as to selectively wipe one or more than one of the printheads 125 which eject printing liquid and to selectively not wipe one or more than one of the printheads 125 which eject non-printing liquid such as optimiser liquid. This may inhibit cross contamination between different liquids, such as the different liquids described above.

The one or more than one wiping blade 170 of the wiping station 130 may wipe the printhead 125 by positioning the one or more than one wiping blade 170 such that the one or more than one wiping blade 170 contacts the printhead 125 when the printhead 125 and the wiping blade 170 are aligned, and subsequently moving the printhead 125 in relation to the one or more than one wiping blade 170 such that wiping of the printhead 125 by the one or more than one wiping blade 170 occurs. The printhead 125 may be moved in relation to the one or more than one wiping blade 170 of the wiping station 130 in any direction in the printing plane (e.g., the x-y plane in FIG. 1) in order to cause wiping of the printhead 125. For example, the printhead 125 may be moved relative to the wiping station 130 in the forward pass direction or the reverse pass direction, or alternatively in any other direction parallel to the printing plane.

Said movement may comprise movement of the printhead 125, movement of the wiping station 130, movement of the one or more than one wiping blade 170, or any combination thereof.

In examples wherein the wiping station 130 comprises more than one wiping blade 170, it may be that the constituent wiping blades 170 of the more than one wiping blade 170 are offset from each other in the forward or reverse pass direction. It may be that the constituent wiping blades are arranged to wipe the printhead 125 in series with each other.

The force with which one or more than one of the one or more than one wiping blade 170 of the wiping station 130 wipes the printhead 125 may be (e.g. individually) adjustable by the controller 190, for example depending on the at least one printing parameter. This will be discussed in more detail below.

In some examples, the printer 100 may comprise a second wiping station 180. The second wiping station 180 may comprise any of the features of the wiping station 130, and accordingly, for brevity, a fully description of the wiping station 180 has been omitted. The second wiping station 180 may be located on the same side of the printer 100 (in relation to the printing zone 140) as the wiping station 130. The second wiping station may be located adjacent to the wiping station 130. The second wiping station may be spatially separated from the wiping station 130. The second wiping station may be located on the opposite end of the printing zone 140 from the wiping station 130, for example, as shown in FIGS. 1 and 2. The second wiping station 180 may comprise a dry wipe. For example, the wiping station 130 may comprise one or more wet wipes and the second wiping station may comprise one or more dry wipes. It may be that a combination of dry and wet wipes provides a more effective cleaning of the printhead than, for example, dry or wet wipes alone. The printer 100 may comprise any number of wiping stations, each of which may comprise one, more than one or all of the features of the wiping station 130.

The controller 190 may be operable to control one or more aspects of the printer and/or printing operations such as, for example, at least one, or both of, printing operations and wiping operations. The controller 190 may comprise an input interface (not shown) through which it may receive printing content to be printed, in the form of a printing job or otherwise. The input interface may be communicatively coupled to a computer (not shown) from which it may receive said printing content. The computer may also specify one or more printing parameters such as printing mode or printing job length, for example as part of the printing job or separately therefrom. The input interface may be communicatively coupled to the computer by way of a wired or wireless connection, for example.

As discussed above, the controller 190 may be operable to print the printing content onto a printing medium by causing the printer carriage 120 to traverse the scan beam 110, in a reciprocating manner, across the printing zone 140, while causing the selective ejection of printing liquid from appropriate nozzles of the printhead 125. The controller 190 may further cause the selective movement of the printing medium during printing.

The controller may be operable to control wiping of the printhead 125. For example, the controller 190 may, additionally, or alternatively, be operable to cause wiping of the printhead 125 in accordance with a first wiping routine. The first wiping routine may comprise periodic wiping of the printhead 125 at a wiping station, such as the wiping station 130, for example. The first wiping routine may comprise periodic wiping of the printhead 125 at each of more than one wiping station, such as at wiping station 130 and at second wiping station 180. The controller 190 may further be operable to obtain at least one printing parameter indicative of a rate of an aggregation of printing liquid deposits on the printhead 125; to determine a wiping period of a second wiping routine depending on the at least one printing parameter, the second wiping routine comprising periodic wiping of the printhead at the wiping station; and to cause wiping of the printhead in accordance with the first and second wiping routines.

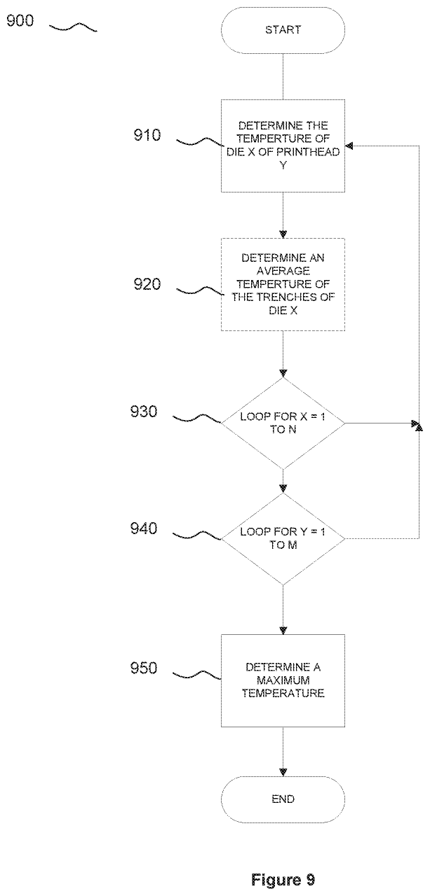

The at least one printing parameter may comprise at least one of the group comprising: a printhead temperature; a printing job length; a printing mode; an environmental humidity; an ambient temperature. The printhead 125 temperature may be measured directly or may be predicted or inferred from other printing parameters. For example, the printhead 125 temperature may be measured in accordance with the example flow chart shown in FIG. 9 discussed hereinafter. Alternatively the printhead 125 temperature may be predicted or inferred from another printing parameter, or a combination of other printing parameters, such as, for example: the printing job length; the printing mode; a drop count corresponding to a number of drops of printing liquid fired over a given time period or during a printing job; an accumulated energy value associated with the drop count; the ambient temperature. Alternatively the temperature of the printhead 125 may be determined using a combination of measuring and predicting/inferring the printhead 125 temperature. Any other means of measuring or predicting/inferring the printhead 125 temperature may be suitable.

In some examples, the controller 190 may obtain the at least one printing parameter by retrieving the at least one printing parameter from a memory. The memory may be internal to the controller 190 or may be external from the controller 190, and communicatively coupled to the controller 190. The memory may be internal to or external from the printer 100. For example, the memory may store; the printing job; the printing job length; the printing mode; or parameters relating thereto.

One or more than one of the at least one printing parameter may be obtained from a computer, such as a computer communicatively coupled to the printer 100, for example to transmit printing jobs to the printer 100.

One or more than one of the at least one printing parameter may be based on sensor data. The sensor data may comprise data corresponding to measurements made by one or more than one sensors. The one or more than one sensors may comprise one or more than one sensor located within the printer 100. The one or more than one sensors may comprise one or more than one sensor located, for example, on the printhead 125. The one or more than one sensors may comprise one or more than one temperature sensor, one or more than one humidity sensor; one or more than one drop detector, for example. The one or more than one temperature sensor may comprise one or more than one printhead temperature sensor. The one or more than one temperature sensor may comprise one or more than one ambient temperature sensor. The one or more than one temperature sensor may comprise one or more than one: thermocouple; resistance temperature detector (RTD); thermistor; solid-state semiconductor based temperature sensor; any other suitable temperature sensor. The one or more than one humidity sensor may comprise one or more than one: capacitive humidity sensor; resistive humidity sensor; thermal humidity sensor; any other suitable humidity. The one or more than one drop detector may comprise any suitable sensor or sensors arranged to determine at least one characteristic of a drop of printing liquid ejected from one or more than one nozzle of the printhead 125. The drop detector may determine at least one of drop count, drop velocity, drop mass or any other drop feature of a drop or drops ejected from one or more than one nozzle.

One or more than one of the at least one printing parameter may be obtained by (e.g. the controller 190) processing one or more than one of: sensor data; a print job, such as a print job comprising printing content; a printing job length; a printing mode. The sensor data may be received from one or more sensors or retrieved from a memory. Any one or more than one of the print job, printing job length and printing mode may be retrieved from a memory or received through the input interface, for example.

In some examples, the controller 190 may obtain the printing job length, the printing mode or both the printing job length and the printing mode by way of the above-described input interface, for example from the said computer which may be external to (e.g. remote from) the printer 100 and communicatively coupled thereto for example wirelessly, by way of a wired connection or by way of a network. The controller 190 may obtain one or more than one of the at least one parameter from the one or more than one sensors.

The controller 190 may comprise circuitry, such as processing circuitry, for example, as described herein.

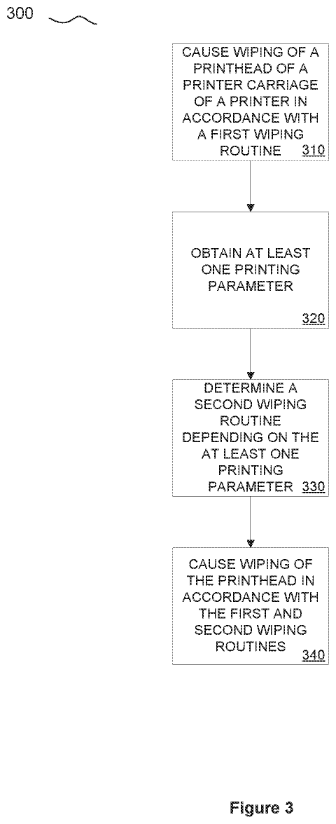

FIG. 3 depicts a flow chart 300 according to an example implementation for wiping a printhead 125 of the printer 100. Flow chart 300 may be performed by the controller 190 but it will be understood that any suitable processing circuitry may alternatively perform flow chart 300. At block 310, wiping of the printhead 125 of the printer carriage 120 of the printer 100 in accordance with a first wiping routine may be caused. The first wiping routine may correspond to, for example, a base level cleaning process of the printer 100 and may comprise periodic wiping of the printhead 125 at the wiping 130 station, or at any other constituent wiping station, such as the second wiping station 180, for example, or at a plurality of wiping stations such as wiping station 130 and second wiping station 180.

The periodic wiping of the first wiping routine may comprise one or more than one periodic wiping events. A wiping event may correspond to the wiping of the printhead 125 which is performed periodically at the wiping station 130 (or alternatively, at any other wiping station, such as the second wiping station 180, for example) as part of a given wiping routine, such as the first wiping routine, for example. In some examples, a wiping event may comprise one or more than one wipes of the printhead 125, by one or more than one wiping blades 170 of a wiping station.

In some examples, in addition to the periodic wiping events, the controller 190 may be configured to cause the ejection of a predetermined amount of at least one printing liquid by the printhead 125 when the printhead is at or adjacent to the wiping station. Said ejection may be referred to as a “spit” and may be performed into a spittoon located adjacent to the wiping station (not shown) for example, or may be performed onto the wiping blade 170 or the cleaning cloth of the wiping station.

It may be that the first wiping routine comprises periodic wiping events at each of a plurality of wiping stations, such as periodic wiping events at the wiping station 130 and periodic wiping events at the second wiping station 180. It may be that the periods of the wiping events at the wiping station 130 and the second wiping station 180 are the same or they may be different from each other.

The wiping period of the first wiping routine may be fixed or may be variable. The wiping period of the first wiping routine may be defined with respect to time wherein the periodic wiping of the printhead at the wiping station is performed at fixed time intervals. Alternatively, the wiping period of the first wiping routine may be defined with respect to the position of the printhead 125 in relation to the printing zone 140. For example, wiping may be performed in accordance with the first wiping routine, periodically, when the printhead 125 is located at a certain position in relation to the printing zone 140. In some examples, this position may correspond to a position beyond an edge of the printing zone 140 e.g., in the forward pass or reverse pass direction, such as beyond the rightmost edge or leftmost edge of the printing zone 140 in FIGS. 1 and 2. In some examples, wiping may be performed in accordance with the first wiping routine between successive forward and reverse passes, or between successive reverse and forward passes, or both. For example, wiping may be performed in accordance with the first wiping routine when the printhead 125 is located beyond the rightmost edge of the printing zone 140 in FIGS. 1 and 2 (e.g. at wiping station 130) after a forward pass (e.g. between successive forward and reverse passes); or beyond the leftmost edge of the printing zone 140 in FIGS. 1 and 2 (e.g. at wiping station 180) after a reverse pass (e.g. between successive reverse and forward passes); or both. In these examples, the wiping period may defined in terms of a number of passes.

The first wiping routine may comprise periodically wiping the printhead 125 with one or more than wiping blade 170 at one or more than one wiping station a given number of times for each constituent wiping station every X number of passes, X is a positive integer. The wiping event may comprise Y number of wipes of the printhead 125 by one or more than one wiping blade 170 at a wiping station, where Y is a positive integer. For example, the first wiping routine may comprise performing a wiping event every two passes, wherein the wiping event comprises, for example, two wipes of the printhead 125 at the wiping station 130, for example by a single wiping blade 170, such as one when the printhead is moving in the forward pass direction between successive forward and reverse passes and one when the printhead is moving in the reverse pass direction between successive forward and reverse passes.

The first wiping routine may comprise periodically performing more than one wiping event, such as, for example, two wiping events. For example, with reference to FIGS. 1 and 2, said first wiping routine may comprise performing one wiping event at the wiping station 130 after every forward pass (e.g. between every forward pass and the successive reverse pass) and performing one wiping event at the second wiping station 180 after every reverse pass (e.g. between every reverse pass and the successive forward pass). The period of said first wiping routine may be “two passes” as there are two passes between successive like wiping events (e.g., two passes between successive wiping events performed at the wiping station 130, and two passes between successive wiping events performed at the second wiping station 180). The wiping period may be said to be the number of passes between successive wiping events at the same wiping station.

Wiping of the printhead 125 in accordance with the first wiping routine may be performed by moving the printhead 125 relative to one or more than one wiping stations such that the one or more than one wiping blade 170 of the one or more than one wiping station wipes the printhead 125 during said movement. Said movement may comprise movement of the printhead 125, movement of the wiping station 130, movement of the one or more than one wiping blade 170, or any combination thereof. In some examples, the position of the one or more than one wiping blade 170 may be fixed such that the one or more than one wiping blade 170 wipe the printhead 125 when the printhead is aligned with the one or more than one wiping blade 170. In other examples, the position of the one or more than one wiping blade 170 may be variable. For example, the one or more than one wiping blade 170 may be retractable and extendable between retracted and extended positions. When in the retracted position, it may be that the one or more than one wiping blade 170 does not wipe the printhead 125 when the printhead is aligned with the one or more than one wiping blade 170 because the wiping blade 170 is positioned so as not to contact the printhead when the wiping blade is aligned with the printhead. When in the extended position, it may be that the one or more than one wiping blade 170 does wipe the printhead 125 when the printhead is aligned with the one or more than one wiping blade 170 because the wiping blade 170 is positioned so as to contact the printhead when the wiping blade is aligned with the printhead.

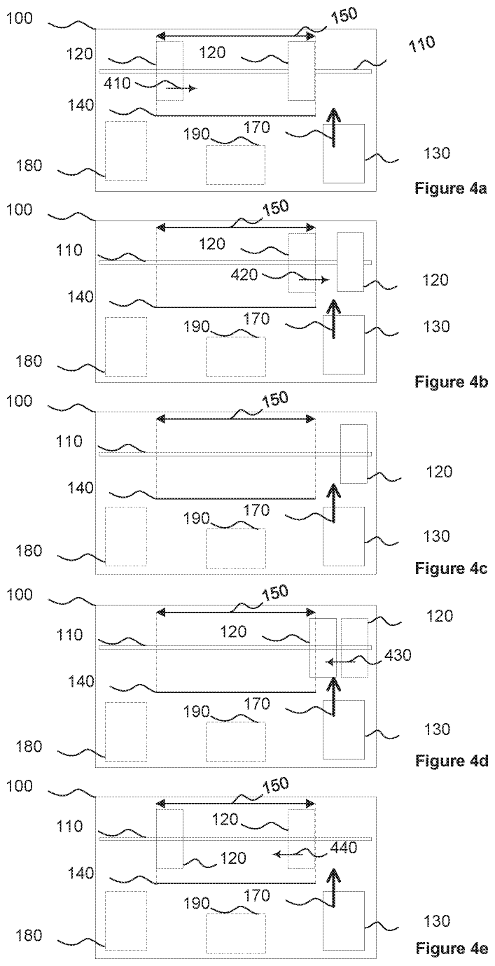

FIGS. 4a-e schematically illustrate a first wiping routine according to an example, wherein the first wiping routine comprises periodic wiping of the printhead 125 of the printer carriage 120 at the wiping station 130, wherein said periodic wiping comprises one wiping event at the wiping station 130, wherein the wiping event comprises one wipe by the wiping blade 170, and wherein the wiping blade 170 is extendable and retractable. As discussed above however, the first wiping routine is not so limited. FIGS. 4a-b and FIGS. 4d-e schematically illustrate the movement of the printer carriage 120 during particular portions of the example first wiping routine. The printer carriage 120 shown with a dashed line corresponds to the position of the printer carriage 120 at the start of each corresponding portion of the example first wiping routine while the printer carriage 120 shown with a solid line corresponds to the position of the printer carriage 120 at the end of each corresponding portion of the example first wiping routine. The arrows 410-440 illustrate the respective direction of movement of the printer carriage 120 during each corresponding portion of the example first wiping routine.

FIG. 4a illustrates the movement of the printer carriage 120 during a forward pass across the printing zone width 140. FIG. 4b shows the printer carriage 120 being provided to the wiping station 130 at the end of the forward pass to undergo wiping in accordance with the first wiping routine. In this example, the wiping station comprises one wiping blade 170, however, as discussed hereinbefore, the wiping station 130 is not so limited.

In FIG. 4b, the wiping blade 170 is in its retracted position such that it does not contact the printhead 125 upon the printer carriage 120 being provided to the wiping station 130 in the forward pass direction. The first wiping routine, however, is not so limited. In other examples, the wiping blade 170 of the wiping station 130 may be extended such that the printhead 125 is wiped by the wiping blade 170 upon being provided to the wiping station 130 in the forward pass direction.

In FIG. 4c, wiping blade 170 is extended towards the printing carriage 120 in its extended position such that the wiping blade 170 contacts the printhead 125 when the printhead 125 and the wiping blade 170 are aligned.

In FIG. 4d, the printing carriage 120 is moved relative to the wiping blade 170 in the reverse pass direction when the wiping blade 170 is in the extended position, thereby causing wiping of the printhead 125 by the wiping blade 170.

In FIG. 4e, the printing carriage 120 returns to the printing zone 140 from the wiping station 130 in the reverse pass direction, the printing carriage subsequently performing a reverse pass. The first wiping routine may comprise one or more than one periodic wiping events. The first wiping routine shown in FIGS. 4a-e comprises one periodic wiping event which in turn comprises one wipe of the printhead 125 by the wiping blade 170 when the printhead 125 is moving in a direction corresponding to a reverse pass (e.g., from right to left in FIGS. 4a-e) towards the printing zone between successive forward and reverse passes. In other examples, the wiping event of the first wiping routine may comprise any number of wipes by any number of wiping blades 170 at the wiping station 130.

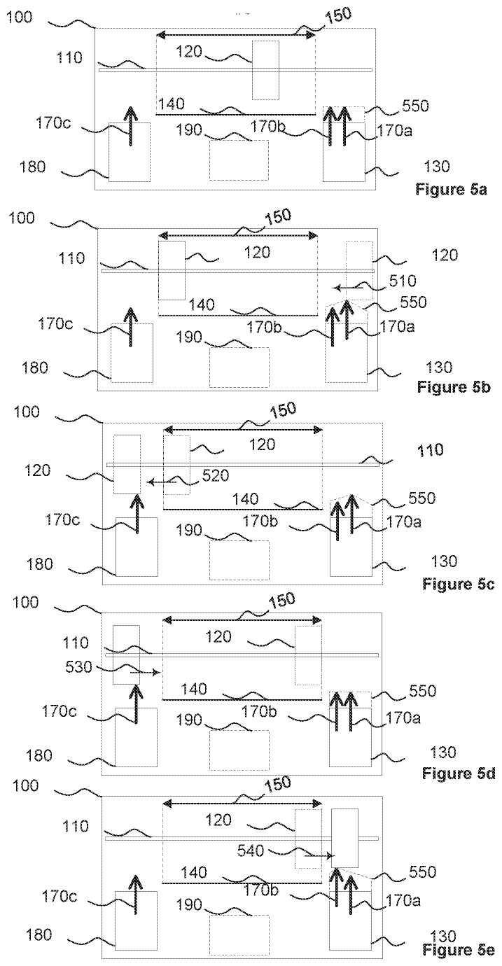

FIGS. 5a-e schematically illustrate a first wiping routine according to another example. FIGS. 5b-e schematically illustrate the movement of the printer carriage 120 during particular portions of this example first wiping routine. The printer carriage 120 shown with a dashed line corresponds to the position of the printer carriage 120 at the start of each corresponding portion of the example first wiping routine while the printer carriage 120 shown with a solid line corresponds to the position of the printer carriage 120 at the end of each corresponding portion of the example first wiping routine. The arrows 510-550 illustrate the respective direction of movement of the printer carriage 120 during each corresponding portion of the example first wiping routine. In this example, the printer 100 comprises two wiping stations, the wiping station 130 and the second wiping station 180. As shown in FIGS. 5a-e, the wiping station 130 comprises two wiping blades 170a and 170b. Wiping blade 170a may be a soft wiping blade while wiping blade 170b may be a hard wiping blade. A cleaning cloth 550, which may comprise solvent, may reside on the wiping surfaces of the wiping blades 170a and 170b. In this example, the second wiping station 180 comprises one wiping blade 170c, which may be a hard wiping blade. The wiping blades of the wiping station 130 may be wet wipes. The wiping blade of the second wiping station 180 may be a dry wipe. In this example, the first wiping routine comprises three wiping events: two wiping events performed at the wiping station 130, and one wiping event performed at the second wiping station 180. One wiping event performed at the wiping station 130 may comprise wiping the printhead 125 of the printer carriage 120 with the soft wiping blade 170a when the printhead 125 is passing the soft wiping blade 170a in the reverse pass direction, for example as shown in FIG. 5b. The other wiping event performed at the wiping station 130 may comprise wiping the printhead 125 of the printer carriage 120 with the hard wiping blade 170b when the printhead 125 is passing the hard wiping blade 170b in the forward pass direction, for example as shown in FIG. 5e. The wiping event performed at the second wiping station 180 may comprise wiping the printhead 125 with the dry wiping blade 170c of the second wiping station 180 both when the printhead 125 is passing the dry wiping blade 170c in the reverse pass direction, for example as shown in FIG. 5c, and when the printhead 125 is passing the dry wiping blade 170c in the forward pass direction, for example as shown in FIG. 5d. Wiping events performed at the wiping station 130 may be performed after every forward pass, and the wiping event performed at the second wiping station 180 may be performed after every reverse pass. Accordingly, the wiping period of the first wiping routine is “two” as the wiping events thereof are repeated after every two passes. As shown in FIGS. 5b and 5d for example, the controller 190 may be configured to cause the ejection of a predetermined amount of at least one printing liquid by the printhead 125 when the printhead is at or adjacent to the wiping station 130 and at or adjacent to the second wiping station 180. In this example, each of the wiping blades 170a-c are extendable and retractable. The controller 190 may be configured to cause the extension and retraction of any constituent wiping blade in accordance with any of the examples described herein. In can be seen from the FIG. 5b that the wiping blade 170a is in an extended position during the above-described corresponding wiping event shown therein, in which the blade 170a contacts the printhead when the blade 170a and the printhead are aligned. Prior and subsequent to this wiping event, the soft wiping blade 170a may be in a retracted position, such as the retracted position shown in FIGS. 5d-e, in which the blade 170a does not contact the printhead when the blade 170a and the printhead are aligned. In can be seen from the FIGS. 5c-d that the wiping blade 170c is in an extended position during the above-described corresponding wiping event shown therein, in which the blade 170c contacts the printhead when the blade 170c and the printhead are aligned. Prior and subsequent to this wiping event, the hard wiping blade 170c may be in a retracted position, such as the retracted position shown in FIGS. 5a-b and FIG. 5e, in which the blade 170c does not contact the printhead when the blade 170c and the printhead are aligned. In can be seen from the FIG. 5e that the hard wiping blade 170b is in an extended position during the above-described corresponding wiping event shown therein, in which the blade 170b contacts the printhead when the blade 170b and the printhead are aligned. Prior and subsequent to this wiping event, the hard wiping blade 170b may be in a retracted position, such as the retracted position shown in FIGS. 5a-d, in which the blade 170b does not contact the printhead when the blade 170b and the printhead are aligned. In some examples, one or more than one of the wiping blades 170a-c may be extended prior to the printhead 125 being aligned with said one or more than one wiping blade for a corresponding wiping event, for example such that the respective wiping blade wipes all of the nozzles of the printhead during the wiping event. In some examples, one or more than one wiping blade may be selectively extended, selectively retracted or selectively extended and retracted such that one or more than one specific region of the printhead 125 is selectively wiped during a corresponding wiping event. For example one or more than one of the wiping blades 170a-c may be extended from a retracted position after a selected portion of the printhead 125 has passed said one or more than one wiping blade such that one or more than one specific region of the printhead 125 (e.g. the remaining length of the printhead 125 still to pass the wiping blade) is selectively wiped during a corresponding wiping event. In some examples, one or more than one of the wiping blades 170a-c may be retracted from an extended position after a selected portion of the printhead has been wiped by the wiping blade during a corresponding wiping event such that one or more than one specific region of the printhead 125 is selectively wiped during the corresponding wiping event (e.g. by way of a remaining length of the printhead not being wiped by the retracted wiping blade). As discussed above, in some examples, the printhead 125 may be arranged to eject liquid other than printing liquid, such as optimizer liquid, for example. In these examples, one or than one of the wiping blades 170a-c may selectively extended or retracted before, during or after a corresponding wiping event such that selected regions of the printhead 125 are wiped during the wiping event, such as those from which printing liquid is ejected, for example, and such that selected regions of the printhead 125 are not wiped, such as those from which liquid other than printing liquid (such as optimiser liquid) is ejected, for example. Selectively wiping selected regions of the printhead 125 may inhibit cross contamination between different liquids ejected therefrom, such as cross contamination between different printing liquids or cross contamination between one or more printing liquid and one or more non-printing liquid (e.g. optimiser liquid), for example. Similarly, in some examples in which the printer comprises a plurality of printheads 125, it may be that one or more than one wiping blade may be selectively extended, selectively retracted or selectively extended and retracted such that one or more than one of the printheads 125 is selectively wiped during a corresponding wiping event.

At block 320, at least one printing parameter indicative of a rate of aggregation of printing liquid deposits on the printhead 125 is obtained.

As discussed above, the at least one printing parameter may comprise at least one of the group comprising: a printhead temperature; a printing job length; a printing mode; an environmental humidity; an ambient temperature. The printhead 125 temperature may be measured directly or may be predicted or inferred from other printing parameters. For example, the printhead 125 temperature may be measured in accordance with the example shown in FIG. 9 discussed hereinafter. Alternatively the printhead 125 temperature may be predicted or inferred from another parameter, or a combination of other printing parameters, such as, for example, the printing job length, the printing mode, the drop count corresponding to a number of drops of printing liquid fired over a given time period or during a printing job; an accumulated energy value associated with the drop count; the ambient temperature. Alternatively the temperature of the printhead 125 may be determined using a combination of measuring and predicting/inferring the printhead 125 temperature. Any other means of measuring or predicting/inferring the printhead 125 temperature may be suitable.

One or more than one or each of the at least one printing parameter may be obtained, for example, by retrieving the at least one printing parameter from a memory. For example, the memory may store: the printing job; the printing job length; the printing mode; or parameters relating thereto.

In some examples, one or more than one or each of the at least one printing parameter may be obtained, by retrieving one or more than one parameter based on sensor data from a memory. Said sensor data may correspond to any of the sensor data discussed herein.

One or more than one or each of the at least one printing parameter may be obtained from one or more sensors. One or more than one or each of the at least one printing parameter may be obtained from an input interface of the printer, such as from a computer which may be external to the printer, such as a computer from which printing content is received by the printer. One or more than one of the at least one printing parameter may be obtained by (e.g. the controller 190) processing one or more than one of: sensor data; a print job, such as a print job comprising printing content; a printing job length; a printing mode.

At block 330, a second wiping routine comprising periodic wiping of the printhead 125 at the wiping station 130 may be determined, the wiping period of the second wiping routine being determined depending on the at least one printing parameter obtained at block 320. The second wiping routine may correspond to, for example, a wiping routine which is selectively performed in addition to the first wiping routine.

In some examples, values of the wiping period of the second wiping routine as a function of the at least one parameter may be (e.g. empirically) predetermined. These predetermined values may correspond to (e.g. empirically) predetermined periods of the second wiping routine as a function of the at least one printing parameter which, for a given first wiping routine, would sufficiently inhibit the aggregation of printing liquid deposits on the printhead 125 to maintain an acceptable printing quality. The determination of the wiping period of the second wiping routine at block 330 may be based on such predetermined values as discussed hereinbelow. Accordingly, a high rate of periodic wiping events of the printhead (resulting from the combination of the first and second wiping routines) can be selectively implemented depending on the at least one printing parameter in order to maintain printing quality, while lower rates of periodic wiping events of the printhead can be implemented when sufficient in order to increase throughput. This helps to maintain both printing quality and printing throughput of the printer 100.

The determined wiping period of the second wiping routine may the same or may be different from the period of the first wiping routine. For example, the wiping period of the first wiping routine may comprise one wiping event for every two forward passes. The wiping period of the second wiping routine may also comprise one wiping event for every two forward passes or alternatively, may comprise any other number of wiping events per any number of passes.

In some examples the second wiping routine may be in phase or may be out of phase with the first wiping routine. The second wiping routine may be defined as being in phase with the first wiping routine when the wiping of the printhead 125 in accordance with the second wiping routine is performed while the printhead 125 is already located at the wiping station 130 as part of the first wiping routine. The second wiping routine may be defined as being out of phase with the first wiping routine when the wiping of the printhead 125 in accordance with the second wiping routine is performed when the printhead is not already located at the wiping station 130 as part of the first wiping routine.

Example first and second wiping routines are shown in tables 1-4. In these examples, the wiping events of the first and second wiping routines are defined in relation to successive passes of the printing zone 140 by the printing carriage 120. The leftmost column of tables 1-4 labels these successive passes in terms of the pass direction (forward/reverse) and a pass number, wherein the pass number corresponds to the total number of passes which have occurred in the corresponding direction. The middle and rightmost columns define the corresponding wiping events performed in accordance with the first and second wiping routines, respectively. In these examples, the wiping events are performed subsequent to the pass defined in the corresponding row of the leftmost column of the corresponding table, and before performing the next pass. These tables assume that a single wiping station is used for the first and second wiping routines, but it will be understood that the first and second wiping routines are not so limited.

In the example shown in table 1, the periods of the first wiping routine and the second wiping routine are the same and the first and second wiping routines are out of phase with each other. The wiping period of the first wiping routine and the wiping period of the second wiping routine is one wiping event per four passes. In the example shown in table 1, the first wiping routine is out of phase with the second wiping routine in that, the second wiping routine executes wiping events at the wiping station 130 when the printhead 125 is not already located at the wiping station 130 as part of the first wiping routine.

In the example shown in table 2, the periods of the first wiping routine and the second wiping routine are different and the first and second wiping routines are out phase with each other. In the example shown in table 2, the wiping period of the first wiping routine is one wiping event per four passes whereas the wiping period of the second wiping routine is one wiping event per every eight passes. In the example shown in table 2, the first wiping routine is out of phase with the second wiping routine in that, the second wiping routine executes wiping events at the wiping station 130 when the printhead 125 is not already located at the wiping station 130 as part of the first wiping routine.

In the example shown in table 3, the period of the first wiping routine and the second wiping routine are the same and the first and second wiping routines are in phase with each other. In the example shown in table 3, the wiping period of both the first wiping routine and the second wiping routine is one wiping event per two passes. In the example shown in table 3, the second wiping routine is in phase with the first wiping routine in that, the second wiping routine executes wiping events at the wiping station 130 when the printhead 125 is already located at the wiping station 130 as part of the first wiping routine, for example between successive forward and reverse passes.

In the example shown in table 4, the periods of the first wiping routine and the second wiping routine are the different and the first and second wiping routines are in phase with each other. In the example shown in table 4, the wiping period of the first wiping routine is one wiping event per two passes whereas the wiping period of the second wiping routine is one wiping event per four passes. In the example shown in table 4, the second wiping routine is in phase with the first wiping routine in that, the second wiping routine executes wiping events at the wiping station 130 when the printhead 125 is already located at the wiping station 130 as part of the first wiping routine, for example between successive forward and reverse passes.

TABLE 1

| Pass | First Wiping Routine | Second Wiping Routine |
|---|---|---|
| Forward pass 1 | Perform wiping event at the wiping | |
| | station 130 in accordance with the | |
| | first wiping routine. | |
| Reverse pass 1 | | |
| Forward pass 2 | | Perform wiping event at the wiping |
| | | station 130 in accordance with the |
| | | second wiping routine. |
| Reverse pass 2 | | |
| Forward pass 3 | Perform wiping event at the wiping | |
| | station 130 in accordance with the | |
| | first wiping routine. | |
| Reverse pass 3 | | |
| Forward pass 4 | | Perform wiping event at the wiping |
| | | station 130 in accordance with the |
| | | second wiping routine. |
| Reverse pass 4 | | |

TABLE 2

| Pass | First Wiping Routine | Second Wiping Routine |
|---|---|---|
| Forward pass 1 | Perform wiping event at the wiping | |
| | station 130 in accordance with the | |
| | first wiping routine. | |
| Reverse pass 1 | | |
| Forward pass 2 | | Perform wiping event at the wiping |
| | | station 130 in accordance with the |
| | | second wiping routine.. |
| Reverse pass 2 | | |
| Forward pass 3 | Perform wiping event at the wiping | |
| | station 130 in accordance with the | |
| | first wiping routine. | |
| Reverse pass 3 | | |
| Forward pass 4 | | |
| Reverse pass 4 | | |
| Forward pass 5 | Perform wiping event at the wiping | |
| | station 130 in accordance with the | |
| | first wiping routine. | |
| Reverse pass 5 | | |
| Forward pass 6 | | Perform wiping event at the wiping |
| | | station 130 in accordance with the |
| | | second wiping routine. |

TABLE 3

| Pass | 1^{st} Routine | 2^{nd} Routine |
|---|---|---|
| Forward pass 1 | Perform wiping event at the wiping | Perform wiping event at the wiping |
| | station 130 in accordance with the | station 130 in accordance with the |
| | first wiping routine. | second wiping routine. |
| Reverse pass 1 | | |
| Forward pass 2 | Perform wiping event at the wiping | Perform wiping event at the wiping |
| | station 130 in accordance with the | station 130 in accordance with the |
| | first wiping routine. | second wiping routine. |
| Reverse pass 2 | | |
| Forward pass 3 | Perform wiping event at the wiping | Perform wiping event at the wiping |
| | station 130 in accordance with the | station 130 in accordance with the |
| | first wiping routine. | second wiping routine. |
| Reverse pass 3 | | |
| Forward pass 4 | Perform wiping event at the wiping | Perform wiping event at the wiping |
| | station 130 in accordance with the | station 130 in accordance with the |
| | first wiping routine. | second wiping routine. |
| Reverse pass 4 | | |
| Forward pass 5 | Perform wiping event at the wiping | Perform wiping event at the wiping |
| | station 130 in accordance with the | station 130 in accordance with the |
| | first wiping routine. | second wiping routine. |

TABLE 4

| Pass | 1^{st} Routine | 2^{nd} Routine |
|---|---|---|
| Forward pass 1 | Perform wiping event at the wiping | Perform wiping event at the wiping |
| | station 130 in accordance with the | station 130 in accordance with the |
| | first wiping routine. | second wiping routine. |
| Reverse pass 1 | | |
| Forward pass 2 | Perform wiping event at the wiping | |
| | station 130 in accordance with the | |
| | first wiping routine. | |
| Reverse pass 2 | | |
| Forward pass 3 | Perform wiping event at the wiping | Perform wiping event at the wiping |
| | station 130 in accordance with the | station 130 in accordance with the |
| | first wiping routine. | second wiping routine. |
| Reverse pass 3 | | |
| Forward pass 4 | Perform wiping event at the wiping | |
| | station 130 in accordance with the | |
| | first wiping routine. | |
| Reverse pass 4 | | |
| Forward pass 5 | Perform wiping event at the wiping | Perform wiping event at the wiping |
| | station 130 in accordance with the | station 130 in accordance with the |
| | first wiping routine. | second wiping routine |

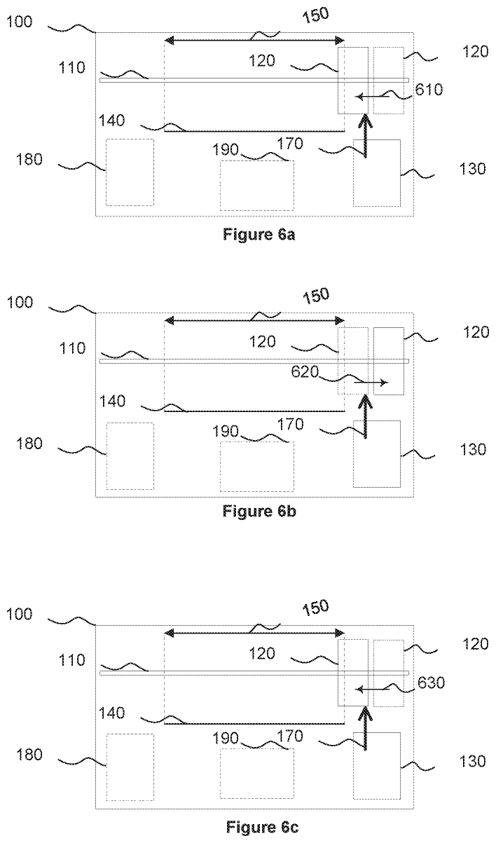

FIGS. 6a-c schematically illustrate a second wiping routine according to an example, wherein the second wiping routine is in phase with the first wiping routine and comprises periodic wiping events of the printhead 125 at the wiping station 130, wherein said periodic wiping events comprise a wiping event at the wiping station 130, wherein the wiping event comprises two wipes of the printhead by the wiping blade 170, however, as already discussed, the second wiping routine is not so limited. FIGS. 6a-c schematically illustrate the movement of the printer carriage 120 during particular portions of this example second wiping routine. The printer carriage 120 shown with a dashed line corresponds to the position of the printer carriage 120 at the start of each corresponding portion of the example second wiping routine while the printer carriage 120 shown with a solid line corresponds to the position of the printer carriage 120 at the end of each corresponding portion of the example second wiping routine. The arrows 610-630 illustrate the respective direction of movement of the printer carriage 120 during each corresponding portion of the example second wiping routine.

FIG. 6a corresponds to the position of the printer carriage in FIG. 4d during the first wiping event and schematically illustrates the position of the printer carriage subsequent to a wiping event in accordance with a first wiping routine, prior to undertaking a reverse pass.

FIGS. 6b and c schematically illustrate a wiping event in accordance with the second wiping routine. Said wiping event is performed when the printer carriage 120 is already at the wiping station 130 as part of the first wiping routine. Said wiping event comprises the movement of the carriage 120 in a forward pass direction (FIG. 6b) followed by the movement of the carriage 120 in a reverse pass direction (FIG. 6c), thereby causing wiping of the printhead 125 by the wiping blade 170 both when the printhead 125 passes the wiping blade 170 in the forward pass direction and when the printhead 125 subsequently passes the wiping blade 170 in the reverse pass direction, the blade 170 remaining in its extended position. As above, for the second wiping routine, it may be that the wiping blade 170 is arranged to selectively wipe specific regions of the printhead 125, such as to selectively wipe a particular set or sets of nozzles of the printhead 125. Similarly, in some examples in which the printer comprises a plurality of printheads 125, it may be that as part of the second wiping routine one or more than one wiping blade may be selectively extended, selectively retracted or selectively extended and retracted such that one or more than one of the printheads 125 is selectively wiped during a corresponding wiping event.

FIG. 6c also corresponds to the position of the printer carriage in FIG. 4d during the first wiping event and schematically illustrates the position of the printer carriage 120 subsequent to a wiping event in accordance with the second wiping routine. Following this wiping event of the second wiping routine, the printer carriage may undertake a reverse pass as shown in FIG. 4e. Implementing first and second wiping routines in phase with each other may increase the printing throughput, as the additional wiping event or events performed according to the second wiping routine is/are performed while the printing carriage 120 is already located at the wiping station 130, thereby reducing any additional movement of the printer carrier 120 in order to perform second wiping routine.

Returning to the flow chart shown in FIG. 3, the wiping period of the second wiping routine may be determined depending on the at least one printing parameter obtained at block 330. As already discussed herein, values of the wiping period of the second wiping routine as a function of the at least one parameter may be (e.g. empirically) predetermined. These predetermined values may correspond to (e.g. empirically) predetermined periods of the second wiping routine as a function of the at least one printing parameter which, for a given first wiping routine, would sufficiently inhibit the aggregation of printing liquid deposits on the printhead 125 to maintain an acceptable printing quality. In some examples, the wiping period of the second wiping routine may be determined, based, at least in part, on a comparison between the at least one printing parameter and a correlation table, wherein the correlation table comprises said predetermined periods of the second wiping routine as a function of the at least one printing parameter. The correlation table may correspond to a table, such as a look up table, or any other suitable data structure such as an array, for example. In other examples, the above-discussed predetermined periods of the second wiping routine as a function of the at least one printing parameter may be approximated by a formula, which may be determined empirically or otherwise. In these examples, the wiping period of the second wiping routine may be determined at block 330 based, at least on part, on said formula.

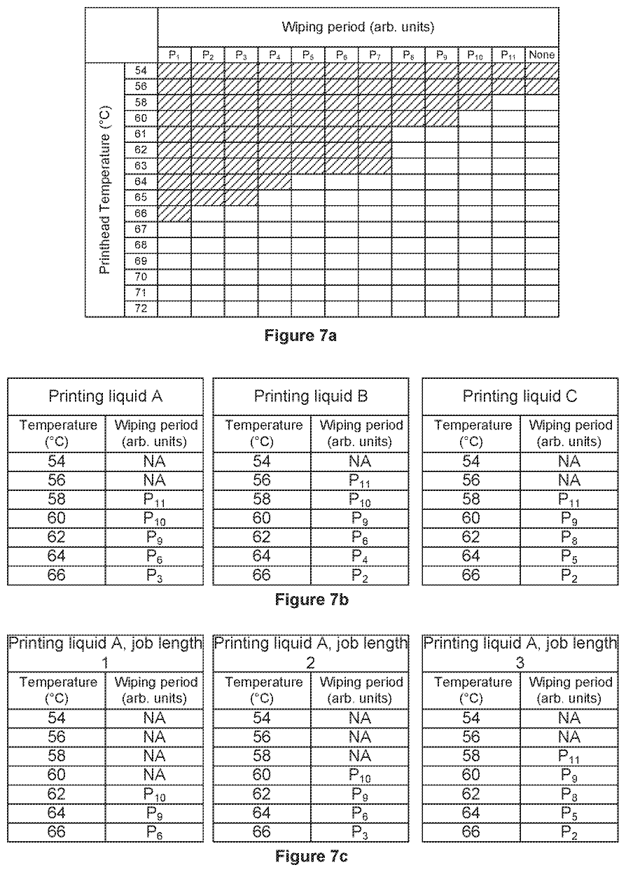

Example correlation tables are shown in FIGS. 7a-c. In these examples, the values of the wiping period of the second wiping routine are denoted by the symbol Pₙ, where n=1 to 11, and where Pₙ<Pₙ₊₁ (e.g., P₁<P₂<P₃ etc.).

In some examples, such as when the one or more than one printing liquid of the printer 100 comprises one or more than one latex based ink, for example, the rate of aggregation of printing liquid deposits on the printhead 125 may primarily be a function of the printhead temperature. In these examples, the aggregated printing liquid deposits on the printhead 125 may correspond to aggregated polymerized latex based ink. The rate of aggregation of polymerized latex based ink deposits may depend on at least the corresponding latex polymerization temperature. This rate may also depend on at least one of: an ambient temperature; an environmental humidity.

FIG. 7a shows a correlation table wherein the wiping period of the second wiping routine is a function of the temperature of the printhead 125. The printhead 125 temperature may be measured directly or may be predicted or inferred from other printing parameters. For example, the printhead 125 temperature may be measured in accordance with the example shown in FIG. 9 discussed hereinafter. Alternatively the printhead 125 temperature may be predicted or inferred from another parameter, or a combination of other printing parameters, such as, for example, the printing job length, the printing mode, the drop count corresponding to a number of drops of printing liquid fired over a given time period or during a printing job; an accumulated energy value associated with the drop count; the ambient temperature. Alternatively the temperature of the printhead 125 may be determined using a combination of measuring and predicting/inferring the printhead 125 temperature. Any other means of measuring or predicting/inferring the printhead 125 temperature may be suitable.

In the example correlation table shown in FIG. 7a, the shaded boxes correspond to combinations of printhead temperature and selected wiping periods of the second wiping routine which, for a given first wiping routine and a given printing liquid, have been determined (e.g. empirically) to maintain a printing quality while the printhead remains at the corresponding temperature. It can be seen that higher printhead temperatures may be associated with shorter wiping periods of the second wiping routine in order to sufficiently maintain printing quality.

In some examples, the controller 190 may be configured to decrease the wiping period of the second wiping routine in response to an increasing printhead temperature.

FIG. 7b shows example correlation tables wherein the wiping period of the second wiping routine for a given printing liquid (denoted printing liquid A, B or C) is a function of the temperature of the printhead 125. It can be seen that for a given printhead 125 temperature, the predetermined wiping period of the second wiping routine may change depending on the printing liquid.

FIG. 7c shows example correlation tables wherein the wiping period of the second wiping routine is a function of temperature, printing liquid and printing job length. It can be seen that for a given printing liquid and for a given printhead 125 temperature, the wiping period of the second wiping routine may change depending on the printing job length. For example, a longer wiping period may be sufficient for shorter printing job lengths while a shorter wiping period may be more suitable for longer job lengths.

The wiping period of the second wiping routine may be a function of any number of obtained printing parameters.

In addition to determining the period of the second wiping routine, the force with which wiping is to occur by one or more than one wiping blades in accordance with the first wiping routine, the second wiping routine or the first wiping routine and the second wiping routine may also be determined at block 330. This may be controlled by the controller 190 controlling a force by which the respective blade 170 is maintained in its extended position during wiping, for example by the controller 190 controlling an actuator force applied to the respective blade 170. This determination may depend on at least one printing parameter, such as at least one printing parameter obtained at block 320. The force with which wiping is to occur may be (e.g. empirically) predetermined as a function of the at least one printing parameter, such as a force which would, for example in combination with the wiping periods of the first and second wiping routines, sufficiently inhibit the aggregation of printing liquid deposits on the printhead 125 to maintain an acceptable printing quality. For example, this determination may be based, at least in part, on a comparison between the at least one printing parameter and a correlation table. The correlation table may correspond to a table, such as a look up table, or any other suitable data structure such as an array, for example. The correlation table may comprise wiping force as a function of the at least one printing parameter.

In examples wherein one printhead 125 ejects more than one printing liquid, wiping periods associated with the printhead 125 of the second wiping routine may be determined for each constituent printing liquid. For example (e.g. empirically) predetermined periods may be provided for each constituent printing liquid as a function of the at least one printing parameter. It may be that different wiping periods are provided for different constituent printing liquids for a given at least one printing parameter. In these examples, a wiping period may be selected for the second wiping routine which corresponds to the shortest of these determined periods. Alternatively, it may be that the printhead 125 is selectively wiped as discussed above such that each nozzle of the printhead 125 is wiped periodically in accordance with the second wiping routine at the corresponding period for the constituent printing liquid associated with that nozzle, the said corresponding periods being determined for the respective printing liquids depending on the at least one parameter.

In examples where the printer 100 comprises more than one printhead 125, such as more than one printhead 125 each for ejecting printing liquid of a different color, respective wiping periods for each of the constituent printheads 125 may be determined, for example as set out above, for example depending on the printing liquid to be ejected thereby. In some examples, each constituent printhead 125 may be wiped periodically (and in some examples selectively) in accordance with the second wiping routine at their corresponding determined period, respectively. In other examples, each constituent printhead 125 may be wiped periodically in accordance with the second wiping routine, wherein the wiping period for each printhead is the same and corresponds to the shortest determined wiping period of the second wiping routine for the constituent printheads 125. For example, the printer 100 may comprise three printheads 125 corresponding to printing liquids A, B and C respectively. The determined wiping period of the second wiping routine for the constituent printheads 125 may correspond to P₁, P₂, and P₃, respectively. In this example, each of the constituent printheads 125 may be wiped in accordance with the second wiping routine with a wiping period of P₁. Alternatively, each printhead 125 may be selectively wiped in accordance with the second wiping routine at the respective wiping period determined for that printhead 125, in this example wiping periods of P₁, P₂ and P₃ respectively.

At block 340, the wiping of the printhead 125 in accordance with the first and second wiping routines is caused, for example by the controller 190.

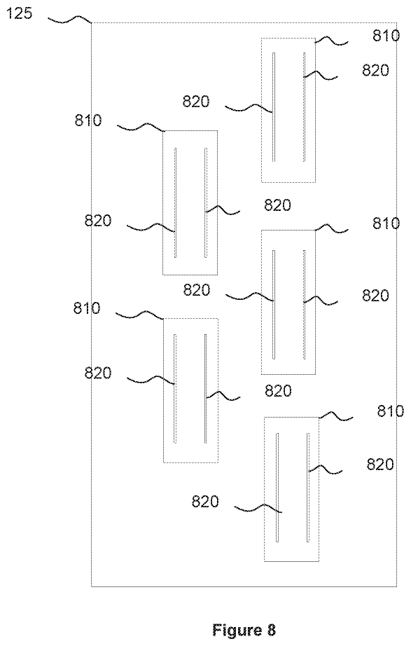

FIG. 8 is a schematic illustration of the printhead 125 of a printer 100 according to some examples. The printhead may comprise one or more than one die 810. Each die 810 may comprise one or more than one trench 820 which may extend longitudinally along the die. Each trench 810 may comprise one or more than one nozzles (not shown) through which one or more than one printing liquids may be ejected. While the example printhead 125 shown in FIG. 8 comprises five dies in total, each of which comprise two trenches, the printhead 125 is not so limited, and the printhead 125 may comprise any number of dies 810, each of which may comprise any number of trenches 820.

The printhead 125 may eject one printing liquid or may eject more than one printing liquids. Said printing liquid(s) may be associated with respective colors. For example, the printhead 125 may eject one printing liquid wherein the color of the one printing liquid is one of cyan, magenta, yellow, black, white, or any other printing liquid color. Alternatively, the printhead 125 may eject more than one printing liquid, each of the printing liquids having a different color. In some examples, the constituent dies of the printhead 125 may be associated with the same or different printing liquids. Alternatively, some of the constituent dies of the printhead 125 may be to dispense the same printing liquid and one or more than one of the constituent dies of the printhead 125 may be to dispense different printing liquids. In some examples, the constituent trenches 820 of each die 810 may be associated with the same or different printing liquids. Alternatively, some of the constituent trenches 820 of each die 810 may be associated with the same printing liquid while one or more than one of the constituent trenches 820 of each die may be associated with a different printing liquid.

FIG. 9 is a flow chart 900 according to an example implementation for determining a temperature of a printhead 125 of a printer 100. At block 910, the temperature of one or more than one trench 820 of a die 810 of a printhead 125 is determined. Said temperature may be determined using any suitable means. For example, one or more than one trench 820 may have an associated temperature sensor, such as a thermocouple, for example, which may be used to measure the temperature of said one or more than one trench 820. In other examples, the temperature of one or more than one trench 820 may be predicted or inferred from at least one printing parameter. For example, the temperature of one or more than one trench 820 may be predicted or inferred based on the drop count of said one or more than one trench 820, or based on any other suitable printing parameter. In other examples, the temperature of one or more than one trench may be determined based on a combination of measuring and predicting the temperature of the said one or more than one trench 820.

At block 920, if the temperatures of more than one trench are determined in block 910, the temperature of each die may be determined based on the average (e.g. mean) of the trench temperatures determined at block 910 for that die.

At block 930, the determinations performed at blocks 910 and 920 may be repeated for dies 1 to N. N may correspond to the number of constituent dies 820 on the printhead 125 or may correspond to a number less than the number of constituent dies 810 on the printhead 125. For example, the printhead may comprise five dies and N may equal five. Alternatively, the printhead may comprise five dies and N may equal any number between 1 and 5.

At block 940, the determinations performed at blocks 910-930 are repeated for printheads 1 to M. M may correspond to the number of constituent printheads 125 of the printer 100 or may corresponds to a number less than the number of constituent printheads 125 of the printer. For example, the printer 100 may comprise eight printheads 125 and M may equal eight. Alternatively, the printer may comprise eight printheads 125 and M may equal any number between 1 and 8.

At block 950, a maximum temperature may be determined based on the determinations performed at blocks 910-940. The maximum temperature may correspond to the highest value of a temperature determined at block 910 or 920.

Blocks 910-950 may be repeated once per pass or may be repeated at different intermediate positions of the printhead in the printing zone 140 between the start and the end of a pass. In some examples, blocks 910-940 may be repeated ten times for each pass. The maximum temperature determined from each repetition of blocks 910-940 may correspond to the at least one printing parameter of block 330 of FIG. 3. In other examples, blocks 910-940 may be repeated any number of times for each pass.

A maximum temperature may thus be determined for each printhead 125. As set out above, the wiping period of the second wiping routine for the printhead 125 may be determined depending on the said maximum temperature for that printhead 125. Respective wiping periods may be determined for the second wiping routine for each of the constituent printheads 125, for example depending on the printing liquid to be ejected thereby. Each constituent printhead 125 may be selectively wiped periodically in accordance with the second wiping routine at their corresponding respective determined period. Alternatively, each constituent printhead 125 may be wiped periodically in accordance with the second wiping routine, wherein the wiping period for each printhead 125 is the same and corresponds to the shortest determined wiping period of the second wiping routine for the constituent printheads 125.

Where the printer 100 comprises a single printhead, it will be understood that M may be set equal to 1.

Although the above example implementations have been described in relation to a printer comprising at least one printhead which traverses a printing medium, it will be appreciated that example implementations can be realised using a printer comprising one or more than one static printhead which does not traverse the printing medium, but rather, spans the medium to be printed. In such example implementations, one or more than one wiper, such as a wiping blade, may be mobile (e.g., free to move in relation to the one or more than static printhead) and may wipe the one or more than one static printhead by moving in relation to one or more than static printhead while contacting the one or more than one static printhead. In some examples, the one or more than one static printhead may move in any direction to a cleaning position away from the printing zone 140 prior to being wiped, and the one or more than one static printhead may be wiped while located in said position before being returned to the printing zone to resume printing. In other examples, the one or more than one static printhead may remain, and be wiped, in the same position as it is situated during printing. In these examples, there may be sufficient room between the one or more than static printhead and a platen which supports the printing medium such that the one or more than one wiping station can fit therebetween.

In this specification, the phrase “at least one of A or B” and the phrase “at least one of A and B” should be interpreted to mean any one or more of the plurality of listed items A, B, etc., taken jointly and severally in any and all permutations.

Where functional units are described as circuitry, such as the controller 190, for example, the circuitry may be general purpose processor circuitry configured by program code to perform specified processing functions. The circuitry may also be configured by modification to the processing hardware. The configuration of the circuitry to perform a specified function may be limited exclusively to hardware, limited exclusively to software, or a combination of hardware modification and software execution. Program instructions may be used to configure the logic gates of general purpose or special purpose processor circuitry to perform a processing function.

Circuitry may be implemented, for example, as a hardware circuit comprising processors, microprocessors, circuits, circuit elements (e.g., transistors, resistors, capacitors, inductors, and so forth), integrated circuits, application specific integrated circuits, programmable logic devices, digital signal processors, field programmable gate arrays, logic gates, registers, semiconductor devices, chips, microchips, chip sets, and the like.

The processors may comprise general purpose processors, network processors that process data communicated over a computer network, or other types of processor, including reduced instruction set computers or complex instruction set computers. Each processor may have a single or a multiple core design. Multiple core processors may integrate different processor core types on the same integrated circuit die.

The controller 190 described herein may be implemented in whole or in part by machine-readable program instructions. Machine-readable program instructions may be provided on a transitory medium, such as a transmission medium, or on a non-transitory medium, such as a storage medium. These machine-readable instructions (computer program code) may be implemented in a high level procedural or object oriented programming language. However, the program(s) may be implemented in assembly or machine language, if desired. In any case, the language may be a compiled or interpreted language, and combined with hardware implementations.

Examples of the present disclosure are applicable for use with all types of semiconductor integrated circuit (IC) chips. Examples of these IC chips include but are not limited to processors, controllers, chipset components, programmable logic arrays, memory chips, and network chips. One or more of the components described herein may be embodied as a System On Chip (SOC) device. A SOC may include, for example, one or more Central Processing Unit cores, one or more Graphics Processing Unit cores, an Input/Output interface, and a memory controller. In some examples, a SOC and its components may be provided on one or more integrated circuit die; for example, they may be packaged into a single semiconductor device.

The disclosure also extends to the following examples.

Example 1: A method of cleaning a printhead of a printer, the method comprising: causing wiping of the printhead in accordance with a first wiping routine, the first wiping routine comprising periodic wiping of the printhead, for example at a wiping station; obtaining at least one printing parameter indicative of a rate of an aggregation of printing liquid deposits on the printhead; determining a second wiping routine, the second wiping routine comprising periodic wiping of the printhead, for example at the wiping station, the wiping period of the second wiping routine being determined depending on the at least one printing parameter; and causing wiping of the printhead in accordance with the first and second wiping routines.

Example 2: The method of Example 1, wherein the at least one printing parameter comprises at least one of the group comprising: a printhead temperature; a printing job length; a printing mode; an environmental humidity; ambient temperature.

Example 3: The method of any one of Examples 1 or 2, wherein the wiping periods of the first and second wiping routines are defined with respect to passes of the printhead across a printing zone of the printer.

Example 4: The method of any one of Examples 1-3, wherein the wiping period of the second wiping routine is variable depending on the at least one printing parameter.

Example 5: The method of any one of Examples 1-4, wherein the wiping of the printhead in accordance with one or each of the first and second wiping routines comprises: wiping the printhead with a dry wipe; or wiping the printhead with a wet wipe comprising a solvent; or wiping the printhead with a wet wipe comprising a solvent and with a dry wipe.

Example 6: The method of any one of Examples 1-5, further comprising: causing adjustment of a force with which wiping of the printhead is performed in accordance with one or each of the first and second wiping routines depending on the at least one printing parameter.

Example 7: The method of any one of Examples 1-6, wherein the first wiping routine comprises periodic wiping events performed at a wiping station, and wherein the second wiping routine comprises: performing further wiping of the printhead whilst the printhead is at the wiping station in accordance with the first wiping routine in addition to the wiping of the first wiping routine.

Example 8: The method of any one of Examples 1-7 wherein the second wiping routine is in phase the first wiping routine.

Example 9: The method of any one of Examples 1-8 comprising determining the wiping period of the second wiping routine based, at least in part, on a comparison between the at least one printing parameter and a correlation table.

Example 10: The method of any one of Examples 1-9, wherein the wiping period of the second wiping routine is different from the wiping period of the first wiping routine.

Example 11: The method of any one of Examples 1-10, wherein the wiping period of the second wiping routine corresponds to a predetermined value, the predetermined value being a function of the at least one printing parameter.

Example 12: The method of Example 11, wherein the predetermined value is also a function of the first wiping routine, such as any of: the wiping period of the first wiping routine; a number of wiping events per period of the first wiping routine; a number of wipes per wiping event of the first wiping routine.

Example 13: An apparatus, comprising: processing circuitry, the processing circuitry to: cause wiping of a printhead in accordance with a first wiping routine, the first wiping routine comprising periodic wiping events performed on the printhead, for example at a wiping station; obtain at least one printing parameter indicative of a rate of an aggregation of printing liquid (e.g. ink) deposits on the printhead; determine a wiping period of a second wiping routine based, at least in part, on a comparison between the at least one printing parameter and a correlation table, the second wiping routine comprising periodic wiping events performed on the printhead, for example at the wiping station; and cause wiping of the printhead in accordance with the first and second wiping routines.

Example 14: An apparatus, comprising: processing circuitry, the processing circuitry to: cause wiping of a printhead in accordance with a first wiping routine, the first wiping routine comprising periodic wiping events performed on the printhead, for example at a wiping station; obtain at least one printing parameter indicative of a rate of an aggregation of printing liquid (e.g. ink) deposits on the printhead; determine a wiping period of a second wiping routine based, at least in part, on the at least one printing parameter, the second wiping routine comprising periodic wiping events performed on the printhead, for example at the wiping station; and cause wiping of the printhead in accordance with the first and second wiping routines.

Example 15: The apparatus of Example 13 wherein the correlation table comprises the wiping period of the second wiping routine as a function of the at least one parameter.

Example 16: The apparatus of any one of Examples 13 to 15, wherein the at least one parameter comprises at least one of: a printhead temperature; an ambient temperature; a printing job length; a printing mode; an environmental humidity.

Example 17: The apparatus of any one of Examples 13-16, wherein the second wiping routine is in phase the first wiping routine.

Example 18: The apparatus of any one of Examples 13-17 wherein the first wiping routine comprises periodic wiping events performed at a wiping station, and wherein the second wiping routine comprises: performing further wiping of the printhead whilst the printhead is at the wiping station in accordance with the first wiping routine in addition to the wiping of the first wiping routine.

Example 19: The apparatus of any one of Examples 13-18 wherein the processing circuitry is configured to vary the wiping period of the second wiping routine depending on the at least one printing parameter.

Example 20: The apparatus of any one of Examples 13-19 wherein the wiping periods of the first and second wiping routines are defined with respect to passes of the printhead across a printing zone of the printer,

Example 21: The apparatus of any one of Examples 13-20 wherein the processing circuitry is configured to vary the wiping period of the second wiping routine depending on the at least one parameter.

Example 20: The apparatus of any one of Examples 13-19 wherein the wiping of the printhead in accordance with one or each of the first and second wiping routines comprises: wiping the printhead with a dry wipe; or wiping the printhead with a wet wipe comprising a solvent; or wiping the printhead with a wet wipe comprising a solvent and with a dry wipe.

Example 21: The apparatus of any one of Examples 13-20 wherein the processing circuitry is further configured to cause adjustment of a force with which wiping of the printhead is performed in accordance with one or each of the first and second wiping routines depending on the at least one printing parameter.

Example 22: The apparatus of any one of Examples 13-21, wherein the wiping period of the second wiping routine is different from the wiping period of the first wiping routine.

Example 23: The apparatus of any one of Examples 13-22, wherein the wiping period of the second wiping routine corresponds to a predetermined value, the predetermined value being a function of the at least one printing parameter.

Example 24: The apparatus of any one of Example 23, wherein the predetermined value is also a function of the first wiping routine, such as any of: the wiping period of the first wiping routine; a number of wiping events per period of the first wiping routine; a number of wipes per wiping event of the first wiping routine.

Example 25: A non-transitory machine-readable storage medium encoded with instructions executable by a processor, the machine-readable storage medium comprising instructions to: cause wiping of a printhead in accordance with a first wiping routine, the first wiping routine comprising periodic wiping events performed on the printhead, for example at a wiping station; obtain at least one printing parameter indicative of a rate of an aggregation of printing liquid (e.g. ink) deposits on the printhead; determine a second wiping routine, the second wiping routine comprising periodic wiping events performed on the printhead, for example at the wiping station, the wiping period of the second wiping routine being determined depending on the at least one printing parameter; and cause wiping of the printhead in accordance with the first and second wiping routines.

Example 26: The non-transitory machine-readable storage medium of Example 25, wherein the at least one printing parameter comprises at least one of: a printhead temperature; an ambient temperature; a printing job length; a printing mode; an environmental humidity.

Example 27: The non-transitory machine-readable storage medium of Example 25 or 26, wherein the first and second wiping routines are in phase with each other.

Example 28: The non-transitory machine-readable storage medium of any one of Examples 25-27 wherein the first wiping routine comprises periodic wiping events performed at a wiping station, and wherein the second wiping routine comprises: performing further wiping of the printhead whilst the printhead is at the wiping station in accordance with the first wiping routine in addition to the wiping of the first wiping routine.

Example 29: The non-transitory machine-readable storage medium of any one of Examples 25-28 wherein the wiping period of the first and second wiping routines are defined with respect to passes of the printhead across a printing zone of the printer.

Example 30: The non-transitory machine-readable storage medium of any one of Examples 25-29 further comprising instructions to vary the period of the second wiping routine depending on the at least one printing parameter.

Example 31: The non-transitory machine-readable storage medium of any one of Examples 25-30 wherein the wiping of the printhead in accordance with one or each of the first and second wiping routines comprises: wiping the printhead with a dry wipe; or wiping the printhead with a wet wipe comprising a solvent; or wiping the printhead with a wet wipe comprising a solvent and with a dry wipe.

Example 32: The non-transitory machine-readable storage medium of any one of Examples 25-31 further comprising instructions to cause adjustment of a force with which wiping of the printhead is performed in accordance with one or each of the first and second wiping routines depending on the at least one printing parameter.

Example 33: The non-transitory machine-readable storage medium of any one of Examples 25-32, wherein the wiping period of the second wiping routine is different from the wiping period of the first wiping routine.

Example 34: The non-transitory machine-readable storage medium of any one of Examples 25-33, wherein the wiping period of the second wiping routine corresponds to a predetermined value, the predetermined value being a function of the at least one printing parameter.

Example 35: The non-transitory machine-readable storage medium of any one of Examples 25-34, wherein the predetermined value is also a function of the first wiping routine, such as any of: the wiping period of the first wiping routine; a number of wiping events per period of the first wiping routine; a number of wipes per wiping event of the first wiping routine.

Example 36: The apparatus of any one of Examples 17-20 wherein the processing circuitry is configured to determine the wiping period of the second wiping routine based, at least in part, on a comparison between the at least one printing parameter and a correlation table.

Example 37: A printer comprising: a printhead; processing circuitry, the processing circuitry to: cause wiping of the printhead in accordance with a first wiping routine, the first wiping routine comprising periodic wiping events performed on the printhead, for example at a wiping station of the printer; obtain at least one printing parameter indicative of a rate of an aggregation of printing liquid deposits on the printhead; determine a wiping period of a second wiping routine based, at least in part, the at least one printing parameter, the second wiping routine comprising periodic wiping events performed on the printhead, for example at the wiping station; and cause wiping of the printhead in accordance with the first and second wiping routines.

Example 38: The printer of Example 37 wherein the processing circuitry is configured to determine the wiping period of the second wiping routine based, at least in part, on a comparison between the at least one printing parameter and a correlation table.

Example 39: The printer of Example 38 wherein the correlation table comprises the wiping period of the second wiping routine as a function of the at least one parameter.

Example 40: The printer of any one of Examples 38 to 39, wherein the at least one parameter comprises at least one of: a printhead temperature; an ambient temperature; a printing job length; a printing mode; an environmental humidity.

Example 41; The printer of any one of Examples 38-40, wherein the second wiping routine is in phase the first wiping routine.

Example 42; The printer of any one of Examples 38-41 wherein the first wiping routine comprises periodic wiping events performed at a wiping station of the printer, and wherein the second wiping routine comprises: performing further wiping of the printhead whilst the printhead is at the wiping station in accordance with the first wiping routine in addition to the wiping of the first wiping routine.

Example 43: The printer of any one of Examples 38-42 wherein the processing circuitry is configured to vary the wiping period of the second wiping routine depending on the at least one printing parameter.

Example 44; The printer of any one of Examples 38-43 wherein the wiping periods of the first and second wiping routines are defined with respect to passes of the printhead across a printing zone of the printer.

Example 45: The printer of any one of Examples 38-44 wherein the processing circuitry is configured to vary the wiping period of the second wiping routine depending on the at least one parameter.

Example 46: The printer of any one of Examples 38-45 wherein the wiping of the printhead in accordance with one or each of the first and second wiping routines comprises: wiping the printhead with a dry wipe; or wiping the printhead with a wet wipe comprising a solvent; or wiping the printhead with a wet wipe comprising a solvent and with a dry wipe.

Example 47: The apparatus of any one of Examples 38-46 wherein the processing circuitry is further configured to cause adjustment of a force with which wiping of the printhead is performed in accordance with one or each of the first and second wiping routines depending on the at least one printing parameter.

Example 48: The apparatus of any one of Examples 38-47, wherein the wiping period of the second wiping routine is different from the wiping period of the first wiping routine.

Example 49: The apparatus of any one of Examples 38-48, wherein the wiping period of the second wiping routine corresponds to a predetermined value, the predetermined value being a function of the at least one printing parameter.

Example 50: The apparatus of Example 49, wherein the predetermined value is also a function of the first wiping routine, such as any of: the wiping period of the first wiping routine; a number of wiping events per period of the first wiping routine; a number of wipes per wiping event of the first wiping routine.

1. A method of cleaning a printhead of a printer, the method comprising:
causing wiping of the printhead in accordance with a first wiping routine, the first wiping routine comprising periodic wiping events performed on the printhead;
obtaining at least one printing parameter indicative of a rate of an aggregation of printing liquid deposits on the printhead;
determining a second wiping routine, the second wiping routine comprising periodic wiping events performed on the printhead, the wiping period of the second wiping routine being determined depending on the at least one printing parameter; and
causing wiping of the printhead in accordance with the first and second wiping routines.

2. The method of claim 1, wherein the at least one printing parameter comprises at least one of the group comprising:
a printhead temperature; a printing job length; a printing mode; an environmental humidity; ambient temperature.

3. The method of claim 1, wherein the wiping periods of the first and second wiping routines are defined with respect to passes of the printhead across a printing zone of the printer.

4. The method of claim 1, wherein the wiping period of the second wiping routine is variable depending on the at least one printing parameter.

5. The method of claim 1, wherein the wiping of the printhead in accordance with one or each of the first and second wiping routines comprises:
wiping the printhead with a dry wipe; or
wiping the printhead with a wet wipe comprising a solvent; or
wiping the printhead with a wet wipe comprising a solvent and with a dry wipe.

6. The method of claim 1, further comprising:
causing adjustment of a force with which wiping of the printhead is performed in accordance with one or each of the first and second wiping routines depending on the at least one printing parameter.

7. The method of claim 1, wherein the first wiping routine comprises periodic wiping events performed at a wiping station, and wherein the second wiping routine comprises:
performing further wiping of the printhead whilst the printhead is at the wiping station in accordance with the first wiping routine in addition to the wiping of the first wiping routine.

8. An apparatus, comprising:
processing circuitry, the processing circuitry to:
cause wiping of a printhead in accordance with a first wiping routine, the first wiping routine comprising periodic wiping events performed on the printhead;
obtain at least one printing parameter indicative of a rate of an aggregation of printing liquid deposits on the printhead;
determine a wiping period of a second wiping routine based, at least in part, on the at least one printing parameter, the second wiping routine comprising periodic wiping events performed on the printhead; and
cause wiping of the printhead in accordance with the first and second wiping routines.

9. The apparatus of claim 8, wherein the at least one parameter comprises at least one of:
a printhead temperature; an ambient temperature; a printing job length; a printing mode; an environmental humidity.

10. The apparatus of claim 8, wherein the second wiping routine is in phase the first wiping routine.

11. The apparatus of claim 8 wherein the processing circuitry is to vary the wiping period of the second wiping routine depending on the at least one printing parameter.

12. A non-transitory machine-readable storage medium encoded with instructions executable by a processor, the machine-readable storage medium comprising instructions for causing the processor to:
cause wiping of a printhead in accordance with a first wiping routine, the first wiping routine comprising periodic wiping events performed on the printhead;
obtain at least one printing parameter indicative of a rate of an aggregation of printing liquid deposits on the printhead;
determine a second wiping routine, the second wiping routine comprising periodic wiping events performed on the printhead, the wiping period of the second wiping routine being determined depending on the at least one printing parameter; and
cause wiping of the printhead in accordance with the first and second wiping routines.

13. The non-transitory machine-readable storage medium of claim 12, wherein the at least one printing parameter comprises at least one of:
a printhead temperature; an ambient temperature; a printing job length; a printing mode; an environmental humidity.

14. The non-transitory machine-readable storage medium of claim 12, wherein the first wiping routine comprises periodic wiping events performed at a wiping station, and wherein the second wiping routine comprises:
performing further wiping of the printhead whilst the printhead is at the wiping station in accordance with the first wiping routine in addition to the wiping of the first wiping routine.
